(19) United States
(12) Patent Application Publication
(10) Pub. No.: US 2018/0276617 A1
(43) Pub. Date: Sep. 27, 2018

(54) ACCEPTED JOB APPLICANT COMMITMENT PREDICTION

(71) Applicant: INTERNATIONAL BUSINESS MACHINES CORPORATION, ARMONK, NY (US)

(72) Inventors: Bharath Duggirala, BANGALORE (IN); Venkataramana Veeshagouni, Visakhapatnam (IN); Prasad Velagapudi, VISAKHAPATNAM (IN)

(21) Appl. No.: 15/466,175

(22) Filed: Mar. 22, 2017

(51) Int. Cl. G06Q 10/10

(52) U.S. Cl. CPC G06Q 10/1053

(57) ABSTRACT

The present invention discloses a method and computer program product for estimating a candidate commitment to an accepted job offer of a company, the method including identifying candidate information associated with the candidate, wherein the candidate information is selected from a group including: monitored social media activity associated with the candidate, a candidate survey result, candidate referral information, an employment history of the candidate, and candidate learning progress, assigning a score between a minimum value and a maximum value for each item within the identified candidate information, calculating an estimated commitment of the candidate based on the assigned score for each item, determining the calculated estimated commitment is lower than a threshold, and confirming the candidate is committed to the accepted job offer.

### BACKGROUND

The present invention relates generally to a method and computer program product for computing, and more particularly to a method and computer program product for job applicant commitment prediction after accepting a job offer.

The human resources department of a company may recruit, identify, interview, select, and provide job offers to job candidates. Once a job offer is extended to and accepted by a candidate, the candidate may continue job searching. Should the candidate prefer an alternate job opportunity, the candidate may accept the alternate opportunity, without notifying the company.

### SUMMARY

Embodiments of the present invention disclose a method and computer program product for estimating a candidate commitment to an accepted job offer of a company, the method including identifying candidate information associated with the candidate, wherein the candidate information is selected from a group including: monitored social media activity associated with the candidate, a candidate survey result, candidate referral information, an employment history of the candidate, and candidate learning progress, assigning a score between a minimum value and a maximum value for each item within the identified candidate information, calculating an estimated commitment of the candidate based on the assigned score for each item, determining the calculated estimated commitment is lower than a threshold, and confirming the candidate is committed to the accepted job offer.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a functional block diagram illustrating a distributed data processing environment, in accordance with an embodiment of the present invention;

FIG. 2 is a flowchart depicting operational steps of a candidate commitment process within the data processing environment of FIG. 1, in accordance with an embodiment of the present invention;

FIG. 3 is a block diagram of internal and external components of computers and servers depicted in FIG. 1, in accordance with an embodiment of the present invention;

FIG. 4 is a block diagram of functional layers of an illustrative cloud computing environment, including the distributed data processing environment depicted in FIG. 1, in accordance with an embodiment of the present disclosure; and

FIG. 5 is a functional block diagram of functional layers of the illustrative cloud computing environment of FIG. 4, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is rather focused on the distinctive features or elements of various embodiments of the present invention.

The present invention generally relates to computing, and more particularly to job applicant commitment prediction to join a company after accepting a job offer. A time gap between a candidate accepting a job offer at a company and beginning a new job at the company may exist. For example, the time gap may be between three and six months. During the time gap, there may be limited or no communication between the company and the candidate. The candidate may continue their job search during the time gap should the accepted offer not be a binding offer. A binding offer is a contractual agreement which legally binds the company and the candidate. Should the candidate continue job searching, the candidate may receive and accept another position at a different company. If the candidate accepts another position at a different company, valuable company resources may be lost while the position remains unfilled and a replacement candidate is not searched for. Due to a potential lack of communication and the candidate not notifying the company, the company recruiter may not realize the candidate will not begin employment on an agreed upon start date until the agreed upon start date has passed. This invention helps to identify a likelihood that the candidate will actually join the company after acceptance of a job offer, and, if the likelihood is low, the recruiter may attempt to increase the likelihood the candidate will join the company by identifying and alleviating any concerns the candidate may have. For example, the recruiter may renegotiate the employment agreement with the candidate or provide an alternate or enhanced job offer, and save an expenditure of additional resources to fill the position a second time. Additionally, determining a candidate's level of commitment to an accepted job may allow the recruiter to identify an alternate or back up candidate, if the likelihood that the candidate will join the company is low.

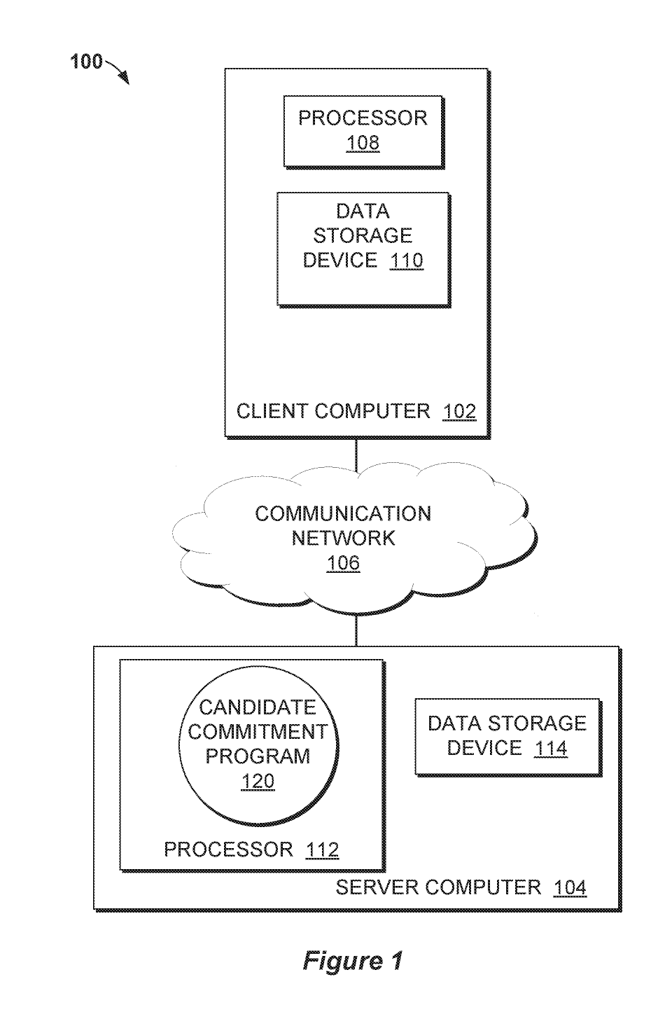

According to an embodiment, a job applicant's commitment after accepting a job offer may be predicted by monitoring the applicant's social media communications, reviewing an applicant survey results and gathering other applicant information, as described below. An embodiment by which to predict a job applicant's commitment after accepting a job offer is described in detail below by referring to the accompanying drawings in FIGS. 1 to 5. Those skilled in the art will readily appreciate that the detailed description given herein with respect to these figures is for explanatory purposes as the invention extends beyond these limited embodiments.

Referring now to FIG. 1, a functional block diagram illustrating a system 100 in a networked computer environment, in accordance with an embodiment of the present invention, is shown. The system 100 may include a client computer 102 and a server computer 104. The client computer 102 may communicate with the server computer 104 via a communications network 106 (hereinafter “network”). The client computer 102 may include a processor 108, a data storage device 110, and is enabled to interface with a user and communicate with the server computer 104. The server computer 104 may also include a processor 112 and a data storage device 114 that is enabled to run a candidate commitment program 120. In an embodiment, the client computer 102 may operate as an input device including a user interface while the candidate commitment program 120 may run primarily on the server computer 104. In an alternative embodiment, the candidate commitment program 120 may run primarily on the client computer 102 while the server computer 104 may be used for processing a storage of data used by the candidate commitment program 120.

It should be noted, however, that processing for the candidate commitment program 120 may, in some instances be shared amongst the client computer 102 and the server computer 104 in any ratio. In another embodiment, the candidate commitment program 120 may operate on more than one server computer 104, client computer 102, or some combination of server computers 104 and client computers 102, for example, a plurality of client computers 102 communicating across the network 106 with a single server computer 104.

The network 106 may include wired connections, wireless connections, fiber optic connections, or some combination thereof. In general, the network 106 can be any combination of connections and protocols that will support communications between the client computer 102 and the server computer 104. The network 106 may include various types of networks, such as, for example, a local area network (LAN), a wide area network (WAN) such as the Internet, a telecommunication network, a wireless network, a public switched network and/or a satellite network.

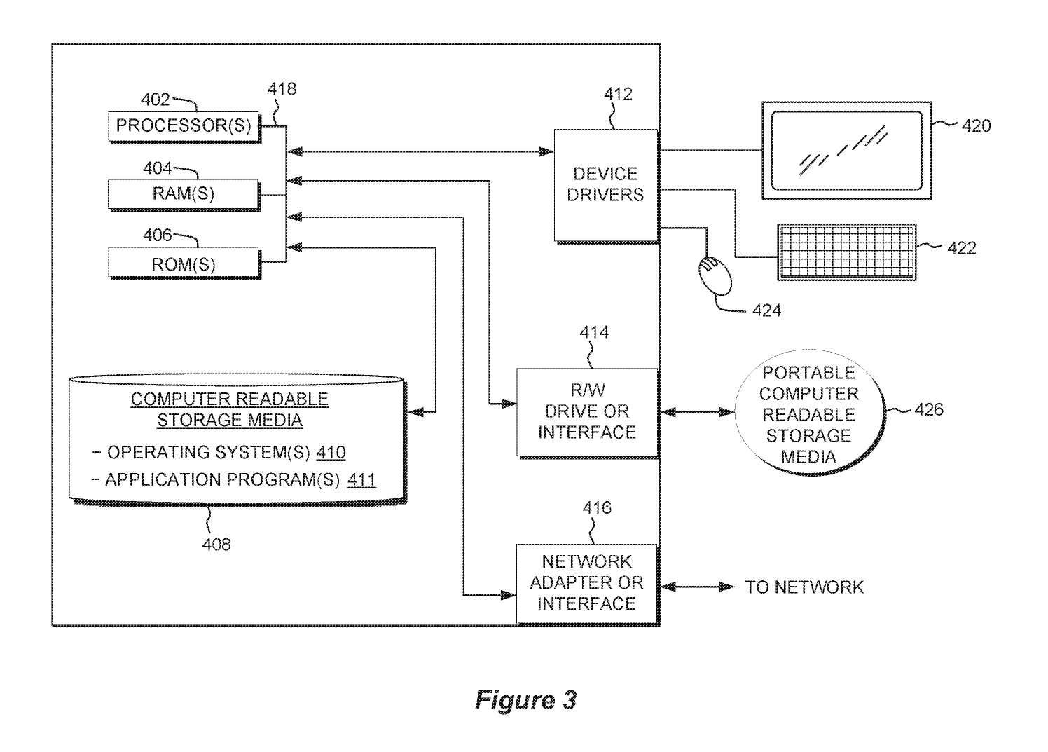

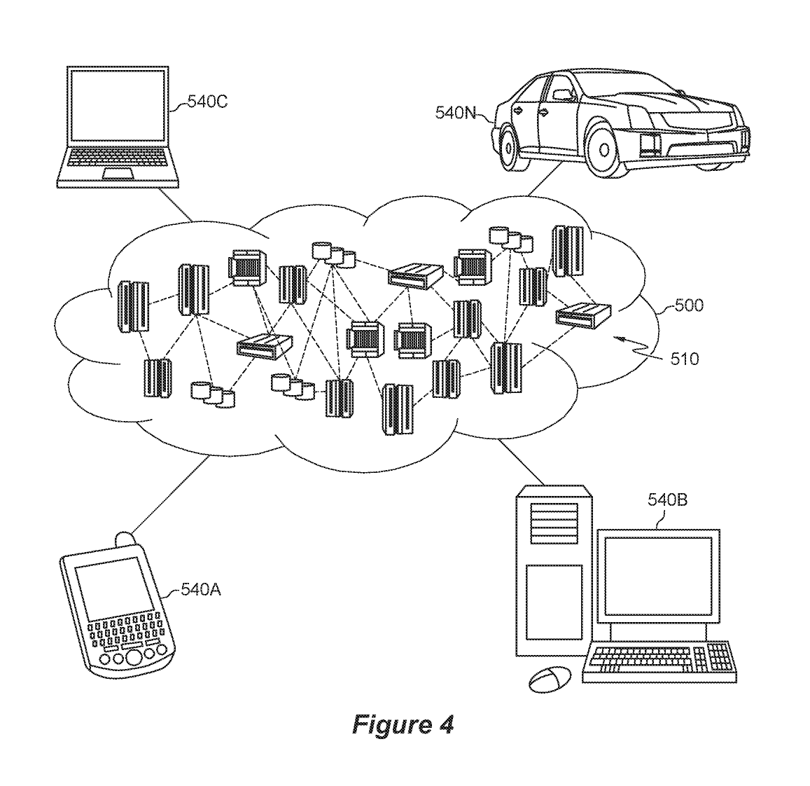

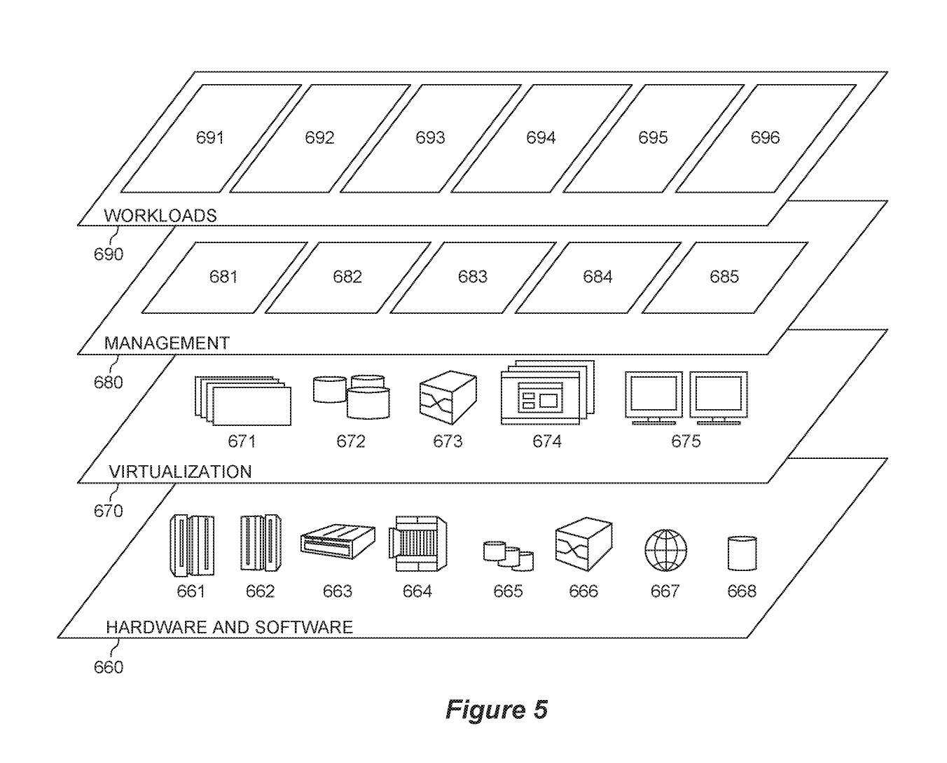

In various embodiments, the client computer 102 and/or the server computer 104 may be, for example, a laptop computer, tablet computer, netbook computer, personal computer (PC), a desktop computer, a personal digital assistant (PDA), a smart phone, a mobile device, or any programmable electronic device capable of communicating with the server computer 104 via the network 106. As described below with reference to FIG. 3, the client computer 102 and the server computer 104 may each include internal and external components. In other embodiments, the server computer 104 may be implemented in a cloud computing environment, for example, cloud computing nodes 510, as described in relation to FIGS. 4 and 5 below. Similarly, the client computer 102 may be implemented in the cloud computing environment, for example, a laptop computer 540C as shown in FIG. 4.

In an embodiment, the system 100 may include any number of client computers 102 and/or server computers 104; however only one of each is shown for illustrative purposes only. It may be appreciated that FIG. 1 provides only an illustration of an implementation and does not imply any limitations with regard to the environments in which different embodiments may be implemented. Many modifications to the depicted environments may be made based on design and implementation requirements. The system 100 may be generally configured to run the candidate commitment program 120 to predict a job applicant's commitment after accepting a job offer.

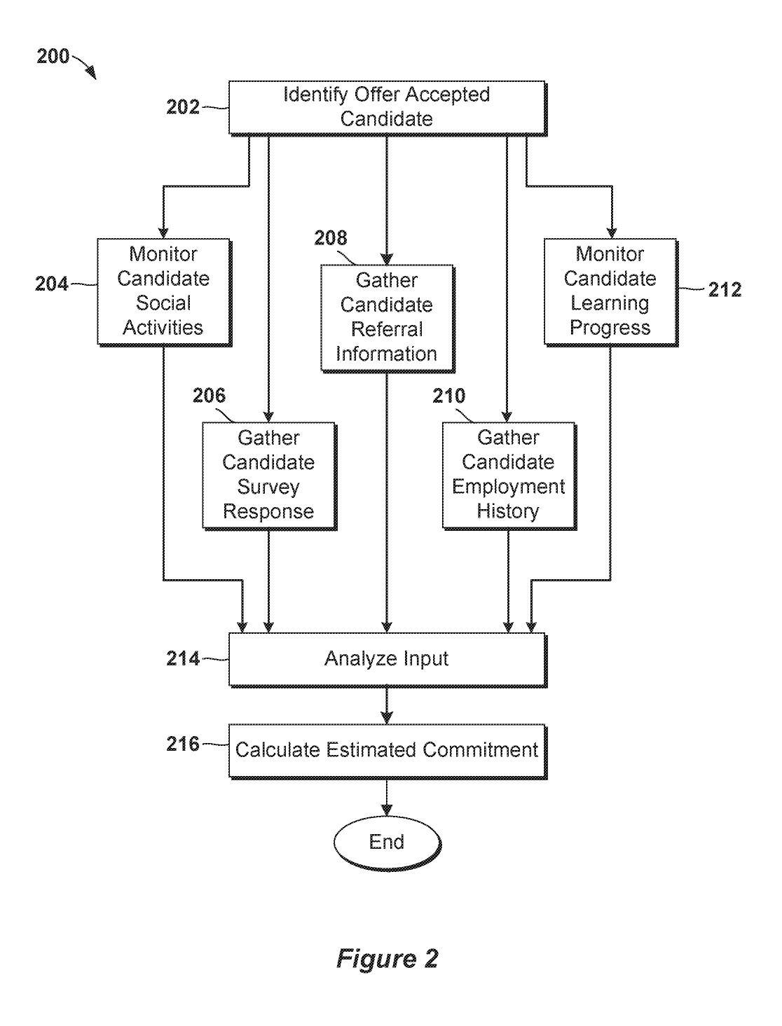

The candidate commitment program 120, and associated methods are described and explained in further detail below with reference to FIGS. 2-5.

Referring now to FIG. 2, and with continued reference to FIG. 1, a simplified diagram of a candidate commitment process 200, illustrating operational steps of the candidate commitment program 120, is shown in accordance with an embodiment of the present invention. The candidate commitment program 120 may be configured to predict a job applicant's commitment after accepting a job offer.

Identification of a candidate who has accepted the job offer is performed at step 202. A job offer from a recruiter and a hiring manager from a company may have been extended to and accepted by the candidate. However, the job offer and the job acceptance may not be binding. A time gap of several months may exist between the job acceptance by the candidate and a start date for the candidate to begin work. During this period, the recruiter and the hiring manager may have little to no contact with the candidate, and the candidate may continue to search for a new job, or may have additional job searches which were already in progress. As a result of a continued job search, the candidate may receive a job offer from another company and may decide against joining the company. An acceptance event may be triggered by the accepted job offer, by email or a scan of the accepted job offer, or by a company representative, such as the human resources manager, manually indicating the candidate acceptance through interactions with a graphical user interface. The acceptance event may trigger the candidate commitment program 120 to be performed.

After identification of the candidate at step 202, the candidate commitment program 120 may concurrently perform steps 204, 206, 208, 210, and 212, as described below. After each of the steps 204, 206, 208, 210, and 212, the candidate commitment program 120 may continue to step 214, as described below. The candidate may provide contact and other information in a job application submitted to the company. The candidate commitment program 120 may use contact and other information provided by the candidate plus internet search engines to locate data and accounts pertaining to the candidate.

At step 204, the candidate commitment program 120 monitors candidate social activities. Monitoring of social activities may include monitoring social media profiles of the candidate on social media sites, monitoring job search activities of the candidate, monitoring any on-line job applications of the candidate, and monitoring any recommendations of the company by the candidate on-line.

Social activities of the candidate may include status changes and updates from social media sites, for example, Twitter® (Twitter® and all Twitter® based trademarks and logos are trademarks or registered trademarks of Twitter Corporation and/or its affiliates), Facebook® (Facebook® and all Facebook® based trademarks and logos are trademarks or registered trademarks of Facebook Corporation and/or its affiliates), and other social media sites and platforms. The candidate may post information, for example the candidate may indicate they had an interview at the company and accepted the job at the company. Alternatively, the candidate may post updates that indicate the candidate is looking for a job, had an interview at a different company, or an offer from the different company was accepted.

Monitoring of on-line job search activities may include searching job recruiting sites, for example, LinkedIn® (LinkedIn® and all LinkedIn® based trademarks and logos are trademarks or registered trademarks of LinkedIn Corporation and/or its affiliates), Careerbuilder® (Careerbuilder® and all Careerbuilder® based trademarks and logos are trademarks or registered trademarks of CareerBuilder, LLC Limited Liability Company and/or its affiliates), Ziprecruiter® (Ziprecruiter® and all Ziprecruiter® based trademarks and logos are trademarks or registered trademarks of Ziprecruiter Corporation its affiliates), and other job recruitment sites and platforms. The candidate may begin following the company and post positive (or alternatively negative) comments about the company. Similarly, the candidate may identify job search activities or indicate they have applied for a job at a different company.

Then, at step 206, the candidate commitment program 120 gathers candidate survey responses. The candidate survey may be sent to the candidate upon their acceptance of the job offer. The candidate survey may be an email response, an online survey, a phone survey or an automated voice call. The candidate survey may include questions, such as how certain the candidate is that the job offer is a good match, how excited the candidate is about the job offer, if the candidate would have to move and if the candidate is willing to move, the candidate's own estimate of a probability of committing to the accepted job, the candidate's opinion of the company, the candidate's opinion of the accepted job, how satisfied the candidate is with the offer in light of the candidate's experience. Additional questions may include whether all questions of the candidate were answered, and feedback on the interview and the hiring experience. Reminders may be sent to the candidate if there is a delay in the candidate participating in the survey. A significant amount of time passing without the candidate participating in the survey may serve as a negative indication that the candidate will not begin the new job as agreed.

Next, at step 208, the candidate commitment program 120 gathers candidate referral information. During the interview process, the candidate may have provided personal references. The human resources manager or hiring manager may contact one or more of the personal references provided by phone or email, and request information, such as a level of commitment the candidate may possess, skill level, professional behavior, whether the candidate is a team player, and how well the candidate performs under stress, among other things. A summary document of the exchange between the company representative and the candidate reference, as well as any provided recommendation letters, may be searched for candidate attributes using known natural language processing techniques.

Additionally, in a situation where a company employee has referred the candidate, a survey may be sent to the employee. The referral survey may inquire into the relationship between the employee and the candidate, confirmation of the candidate's current job title, the candidate's dates of employment and work duties, a description of the candidate's work performance, the candidate's responsibility in performing tasks, the candidate's reason for leaving a position, the employee's hiring recommendation of the candidate, and any other information the employee deems relevant.

Then, at step 210, the candidate commitment program 120 gathers employment history information of the candidate. The employment history information may be collected from a resume provided by the candidate, from employment websites, such as LinkedIn® (LinkedIn® and all LinkedIn® based trademarks and logos are trademarks or registered trademarks of LinkedIn Corporation and/or its affiliates), and from other social media sites. The information collected may include candidate employment duration at previous jobs and the frequency with which the candidate changed jobs, among other indicators.

Next, at step 212, the candidate commitment program 120 monitors recommended learning progress of the candidate. The company may provide learning opportunities for the candidate after the candidate has accepted the job offer. Learning opportunities may help retain or bolster candidate commitment to the company. The learning opportunities may include an opportunity to learn about the company, and provide an opportunity to enhance skills needed in the new job. For example, the learning opportunities may teach new versions of a software which may be recently released. The human resources manager and/or the hiring manager may use a metric to confirm the candidate is participating in the course and how far they have progressed in the course. The candidate participation in the course may be an indicator of how committed the candidate is in starting the new job or position on the agreed date.

Input collected as described above in steps 204, 206, 208, 210, and 212 may be analyzed at step 214. Known evolutionary algorithms may be used to analyze the collected data and may assign a score between a maximum value and a minimum value for each of the steps 204, 206, 208, 210, and 212, where a higher score may indicate a high likelihood of the candidate beginning the new job at the company and a lower score may indicate a low likelihood of the candidate beginning the new job at the company. In an exemplary embodiment, each category from each of the steps 204, 206, 208, 210, and 212 may be assigned either a score of positive 1, negative 1, or 0, with +1 indicating a positive likelihood, −1 indicating a negative likelihood, and 0 indicating either a neutral likelihood or no information available for that particular category. In an alternate embodiment, each category from each of the steps 204, 206, 208, 210, and 212 may be graded and have a score, for example between 0 and +10, with +10 being a high likelihood of the candidate beginning the new job at the company, a 0 indicating a low likelihood of the candidate beginning the new job at the company.

A processing engine, for example a cognitive engine, may identify sentiment of a given input text, for example, input collected in steps 204, 206, 208, 210, and 212, and assign a score to each of the input collected, between the maximum value and the minimum value. A processing engine can analyze and interpret data, including unstructured text, image, audio and video and a third party tool may be used as a processing engine. An application programming interface (API), by which third parties can write code that interfaces with other code, may be used. Third party tools capable of identifying sentiment may be used, for example, IBM® Tone Analyzer™, (IBM and Tone Analyzer are trademarks or registered trademarks of International Business Machines Corporation and/or its affiliates). Tone Analyzer™ uses linguistic analysis to detect three types of tones in written text: emotions, social tendencies, and writing style.

A processing engine may be used when monitoring social activities of the candidate as described above in step 204, when gathering survey results as described above in step 206, when gathering candidate referral information as described above in step 208, when gathering candidate employment history information as described above in step 210, and when monitoring learning progress as described above in step 212.

Third party tools capable of tagging or identifying keywords may be used to evaluate any answers provided by the candidate. For example, when gathering candidate referral information, positive key words may be searched for, such as loyalty, commitment, responsible, and skill. Alternatively, negative key words may be searched for, for example, unreliable, disagreeable, and often late to the office.

Calculation of an estimated commitment for the candidate, or a likelihood calculation for estimating whether the candidate will begin work on the agreed start date, is done at step 216. The candidate commitment program 120 may apply a weight to each of the inputs from steps 204, 206, 208, 210 and 212. The candidate commitment program 120 may apply and alter weights based on a company's employment need, where different categories are assigned greater weight. In an embodiment, there may be a weight assigned to each of the categories from steps 204-212. The weight for each of the categories may be assigned by the human resources department, or the hiring manager, or another entity. The weight for each of the categories may be dynamically set. In an example, each of the five categories of steps 204, 206, 208, 210, and 212, may have a weight of 20%. The weight of each of the five categories may be multiplied by the assigned score of the corresponding category, and added together to calculate the likelihood calculation, or estimate of a candidate commitment to an accepted job offer.

The calculated estimated commitment for the candidate may be provided to the human resources department, from which actions may be taken to retain the candidate, and improve the probability that the candidate will remain with the company. A threshold may be dynamically set by the human resources department, the hiring manager, or another entity, to determine the threshold value between a maximum calculated estimated commitment and a minimum estimated commitment. A calculated estimated commitment above the threshold value may determine that there is a good likelihood the candidate will begin the job on the agreed date. A calculated estimated commitment below the threshold value may determine that there is a low likelihood the candidate will begin the job on the agreed date.

In an example, the calculated estimated commitment for the candidate may range between −1.0 and 1.0, and the threshold may be set to 0.25. If the calculated estimated commitment is below 0.25, there is a low likelihood the candidate will begin work at the company on the agreed date. If the calculated estimated commitment is above 0.25, there is a high likelihood the candidate will begin work at the company on the agreed date.

Following is an embodiment of a calculated estimated commitment for a candidate, Raj, shown below in Table 1. Raj has been selected as a candidate and has accepted a job offer. In this example, the first category of monitor social activities has 4 sub-categories, 1A, 1B, 1C, and 1D. The total weight for category 1, monitor social media activities, is the combined weight of 1A: monitoring if the candidate is applying for new jobs, 15%, 1B: monitoring if the candidate is updating social media profiles, 10%, 1C: monitoring if the candidate is using social media for job hunting, 10%, and 1D: monitoring if the candidate is recommending the company, 10%, has a total weight of 55%, or 0.45. The second category has 2 sub-categories, 2A and 2B. The total weight for category 2, survey questions, is the combined weight of 2A: feedback of interview experience, 5%, and 2B: how well the candidate sees a future at the company, 5%, has a total weight of 10%, or 0.1. The third category of gathering referral information has a weight of 15% or 0.15. The fourth category of gathering employment history has a weight of 15%, or 0.15. The fifth category of identifying learning progress has weight of 15%, or 0.15. A total of the weights is 100% or 1.0. In this example, a cognitive engine sentiment provides either a positive sentiment or a negative sentiment, with scores of +1 for a positive sentiment, and −1 for a negative sentiment for each category. The total range of likelihood the candidate will begin the new job ranges between +1.0 and −1.0. In this example, the likelihood Raj will begin the new job is 0.1. In an embodiment, the threshold may be set to 0.25, and in this example, there is a low likelihood that Raj will begin the new job at the company, as his calculated likelihood is below the threshold.

TABLE 1

| | | | | Cognitive |
|---|---|---|---|---|
| | | | Response | Engine |
| | Category | Weight | Data(Example) | Sentiment |
| 1A | Social Activity - Monitoring | 0.15 | Raj is applying for jobs | Negative(−1) |
| | candidate applying for new jobs | | | |
| 1B | Social Activity - Candidate profile | 0.10 | Raj not updating profile | Neutral (0) |
| | updates | | | |
| 1C | Social Activity - Candidate searching | 0.10 | Raj searching for new | Negative(−1) |
| | for new job | | jobs | |
| 1D | Social Activity - Candidate | 0.10 | Raj is recommending the | Positive(1) |
| | recommending the company | | company | |
| 2A | Survey Question- Feedback of | 0.05 | Raj Response -Great | Positive(1) |
| | interview experience | | | |
| 2B | Survey Question- How the candidate | 0.05 | Raj Response -Excellent | Positive(1) |
| | sees future in the company | | | |
| 3 | Referral sources inputs - personal | 0.15 | Referral response - Well | Positive(1) |
| | behavior of the candidate | | spoken, soft, a good | |
| | | | person | |
| 4 | Stability - How frequently the | 0.15 | Profile data shows, a | Positive(1) |
| | candidate has changed companies | | stable, changed 3 | |
| | | | companies in last 10 | |
| | | | years | |
| 5 | Learning - Checking Progress | 0.15 | Raj not participating in | Negative(−1) |
| | | | the learning courses | |
| | Commitment factor | 0.10 | On a scale between −1.0 | |
| | Calculated: | | and 1.0, the likelihood is | |
| | (0.15*−1) + (0.1*0) + (0.10*−1) + | | 0.20, which is below the | |
| | (0.10*1) + (0.05*1) + (0.05*1) + | | threshold of 0.25 | |
| | (0.15*1) + (0.15*1) + (0.15*−1) | | | |

In a situation where a calculated estimated commitment for an employee is below the threshold, the recruiter and/or the hiring manager may try to retain the candidate for the new job and attempt to contact the candidate. In the example above, the calculated likelihood that Raj will begin the new job is 0.20, which is below the threshold of 0.25. The recruiter and/or the hiring manager may contact Raj and ask Raj if he has any questions and confirm that Raj is satisfied with the accepted job offer.

An alternate embodiment is shown below in Table 2 as an example of an estimated commitment for a candidate. In this example, each of the five categories has 20% weight and each of the five categories has a likelihood calculation assigned as described above between 0 and +10, and a threshold is set to 3.0. The calculation of the estimated commitment for the candidate may be between 0 and +10, in this example. In a situation where information is not available for one of the categories, increased weight may be given to remaining categories.

In this example, the calculation of the estimated commitment for the candidate is 4.2, which is higher than the threshold of 3.0, indicating there is a good likelihood the candidate will begin the job on the agreed date.

TABLE 2

| | | Score | | |
|---|---|---|---|---|
| | | (between 0 | Category | Weighted |
| | Category | and 10) | Weight | Score |
| 1 | Monitor social activities | 5 | 20% | 1 |
| 2 | Gather survey results | 6 | 20% | 1.2 |
| 3 | Gather referral information | 2 | 20% | 0.4 |
| 4 | Gather employment history | 2 | 20% | 0.4 |
| 5 | Identify learning progress | 6 | 20% | 1.2 |
| | TOTAL | | | 4.2 |
| | (range between 0 and +10) | | | |

The candidate commitment program 120 may assist the recruiter and/or the hiring manager in estimating a likelihood that a committed candidate begins work at the new job as agreed. If the likelihood that a committed candidate begins work as agreed is low, or below the threshold, the recruiter and/or the hiring manager may be able to increase the likelihood by contacting the candidate. In addition, the recruiter and/or the hiring manager may begin to identify an alternative candidate as a backup in order to save time if the candidate does not begin work on the agreed date. The candidate commitment program 120 may help the company improve the likelihood a candidate does not begin the new job as scheduled, and save company resources recruiting an alternate candidate. The candidate commitment program 120 may help the company identify situations where a backup candidate may be needed due to a low likelihood the candidate begins the new job as scheduled, and begin work to identify an alternate candidate to reduce the amount of time that an open job remains unfilled.

Referring now to FIG. 3, a block diagram of components of a computing device, such as the client computer 102 or the server computer 104, of the system 100 of FIG. 1, in accordance with an embodiment of the present invention is shown. It should be appreciated that FIG. 3 provides only an illustration of an implementation and does not imply any limitations with regard to the environments in which different embodiments may be implemented. Many modifications to the depicted environment may be made.

The computing device may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, for example, the candidate commitment program 120, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The computing device may also include a R/W drive or interface 414 to read from and write to one or more portable computer readable storage media 426. Application programs 411 on the computing device may be stored on one or more of the portable computer readable storage media 426, read via the respective R/W drive or interface 414 and loaded into the respective computer readable storage media 408.

The computing device may also include the network adapter or interface 416, such as a TCP/IP adapter card or wireless communication adapter (such as a 4G wireless communication adapter using OFDMA technology). Application programs 411 on the computing device may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

The computing device may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics of cloud computing include on-demand self-service, broad network access, resource pooling, rapid elasticity, and measured service, which are each described below.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models include Software as a Service, Platform as a Service, and Infrastructure as a Service, which are each described below.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models include private cloud, community cloud, public cloud, and hybrid cloud, which are each described below.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 500 is depicted. As shown, cloud computing environment 500 includes one or more cloud computing nodes 510 with which local computing devices used by cloud consumers, such as, for example, personal digital assistant (PDA) or cellular telephone 540A, desktop computer 540B, laptop computer 540C, and/or automobile computer system 540N, may communicate. Cloud computing nodes 510 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 540A-N shown in FIG. 4 are intended to be illustrative only and that cloud computing nodes 510 and cloud computing environment 500 can communicate with any type of computerized device over any type of network and/or network addressable connection (e.g., using a web browser).

Referring now to FIG. 5, a set of functional abstraction layers provided by cloud computing environment 500 (as shown in FIG. 1) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 660 includes hardware and software components. Examples of hardware components include: mainframes 661; RISC (Reduced Instruction Set Computer) architecture based servers 662; servers 663; blade servers 664; storage devices 665; and networks and networking components 666. In some embodiments, software components include network application server software 667 and database software 668.

Virtualization layer 670 provides an abstraction layer from which the following examples of virtual entities may be provided: virtual servers 671; virtual storage 672, for example the data storage device 114 as shown in FIG. 1; virtual networks 673, including virtual private networks; virtual applications and operating systems 674; and virtual clients 675.

In an example, management layer 680 may provide the functions described below. Resource provisioning 681 provides dynamic procurement of computing resources and other resources that are utilized to perform tasks within the cloud computing environment. Metering and Pricing 682 provide cost tracking as resources are utilized within the cloud computing environment, and billing or invoicing for consumption of these resources. In an example, these resources may include application software licenses. Security provides identity verification for cloud consumers and tasks, as well as protection for data and other resources. User portal 683 provides access to the cloud computing environment for consumers and system administrators. Service level management 684 provides cloud computing resource allocation and management such that required service levels are met. Service Level Agreement (SLA) planning and fulfillment 685 provide pre-arrangement for, and procurement of, cloud computing resources for which a future requirement is anticipated in accordance with an SLA.

Workloads layer 690 provides examples of functionality for which the cloud computing environment may be utilized. Examples of workloads and functions which may be provided from this layer include: mapping and navigation 691; software development and lifecycle management 692; virtual classroom education delivery 693; data analytics processing 694; transaction processing 695; and candidate commitment prediction 696. Candidate commitment prediction 696 may include estimating a new hire's commitment to joining and remaining at a company after accepting a job offer.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for estimating a candidate commitment to an accepted job offer, the method comprising:
identifying a plurality of candidate information associated with the candidate, wherein the candidate information is selected from a group consisting of monitored social media activity associated with the candidate, a candidate survey result, a plurality of candidate referral information, an employment history of the candidate, and candidate learning progress;
assigning a score between a minimum value and a maximum value for each item within the plurality of identified candidate information;
calculating an estimated commitment of the candidate based on the assigned score of each item;
determining the calculated estimated commitment is lower than a threshold; and
confirming the candidate is committed to the accepted job offer.

2. The method according to claim 1, wherein monitored social media activity of the candidate is selected from a group consisting of a social profile of the candidate on a social media site, a job search activity of the candidate, an on-line job application of the candidate, and an on-line recommendation of the company by the candidate.

3. The method according to claim 1, wherein the candidate survey result comprises:
one or more responses from the candidate corresponding to one or more questions of a personalized candidate survey.

4. The method according to claim 1, wherein the employment history comprises at least one of the following:
a previous employment length of service from a candidate resume and a previous employment length of service from a candidate social media profile on a social media site.

5. The method according to claim 1, wherein calculating the estimated commitment of the candidate further comprises:
applying a weight to each item within the plurality of identified candidate information; and
calculating an estimated commitment of the candidate based on each applied weight.

6. The method according to claim 1, wherein assigning the score between the minimum value and the maximum value for each item within the plurality of identified candidate information, further comprises:
identifying a sentiment with a processing engine to analyze and interpret the identified candidate information for the corresponding item of the group; and
determining the score for each item, wherein the value is between the minimum value and the maximum value based on the identified sentiment.

7. The method according to claim 1, wherein confirming the candidate is committed to the accepted job offer is selected from a group consisting of contacting the candidate, confirming all of a plurality of questions from the candidate are answered, and offering an enhanced job offer to the candidate.

8. A method for estimating a candidate commitment to an accepted job offer, the method comprising:
identifying a plurality of candidate information associated with the candidate, wherein the candidate information is selected from a group consisting of a plurality of monitored social media activity associated with the candidate, a candidate survey result, a plurality of candidate referral information, an employment history of the candidate, and candidate learning progress;
assigning a score between a minimum value and a maximum value for each item within the plurality of identified candidate information;
calculating an estimated commitment of the candidate based on the assigned score of each item; and
determining the calculated estimated commitment is above a threshold.

9. The method according to claim 8, wherein monitored social media activity of the candidate is selected from a group consisting of a social profile of the candidate on a social media site, a job search activity of the candidate, an on-line job application of the candidate, and an on-line recommendation of the company by the candidate.

10. The method according to claim 8, wherein the candidate survey result comprises:
one or more responses from the candidate corresponding to one or more questions of a personalized candidate survey.

11. The method according to claim 8, wherein calculating the estimated commitment of the candidate further comprises:
applying a weight to each item within the identified candidate information; and
calculating an estimated commitment of the candidate based on each applied weight.

12. The method according to claim 8, wherein calculating an estimated commitment of the candidate comprises:
applying a weight to each item within the plurality of identified candidate information; and
calculating an estimated commitment of the candidate.

13. The method according to claim 8, wherein assigning the score between the minimum value and the maximum value for each item within the plurality of identified candidate information, further comprises:
identifying a sentiment with a processing engine to analyze and interpret the identified candidate information for the corresponding item of the group; and
determining the score for each item, wherein the value is between the minimum value and the maximum value based on the identified sentiment.

14. A computer program product for estimating a candidate commitment to an accepted job offer, the computer program product comprising:
one or more computer-readable storage media and program instructions stored on the one or more computer-readable storage media, the program instructions comprising:
program instructions to identify a plurality of candidate information associated with the candidate, wherein the candidate information is selected from a group consisting of monitored social media activity associated with the candidate, a candidate survey result, a plurality of candidate referral information, an employment history of the candidate, and candidate learning progress;
program instructions to assign a score between a minimum value and a maximum value for each item within the plurality of identified candidate information;
program instructions to calculate an estimated commitment of the candidate based on the assigned score for each item;
program instructions to determine the calculated estimated commitment is lower than a threshold; and
program instructions to confirm the candidate is committed to the accepted job offer.

15. The computer program product according to claim 14, wherein monitored social media activity of the candidate is selected from a group consisting of a social profile of the candidate on a social media site, a job search activity of the candidate, an on-line job application of the candidate, and an on-line recommendation of the company by the candidate.

16. The computer program product according to claim 14, wherein the candidate survey result comprises:
one or more responses from the candidate corresponding to one or more questions of a personalized candidate survey.

17. The computer program product according to claim 14, wherein the employment history comprises at least one of the following:
a previous employment length of service from a candidate resume and a previous employment length of service from a candidate social media profile on a social media site.

18. The computer program product according to claim 14, wherein program instructions to calculate the estimated commitment of the candidate further comprises:
program instructions to apply a weight to each item within the plurality of identified candidate information; and
program instructions to calculate an estimated commitment of the candidate based on each applied weight.

19. The computer program product according to claim 14, wherein program instructions to assign the score between the minimum value and the maximum value for each item within the plurality of identified candidate information, further comprises:
program instructions to identify a sentiment with a processing engine to analyze and interpret the identified candidate information for the corresponding item of the group; and
program instructions to determine the score for each item, wherein the value is between the minimum value and the maximum value based on the identified sentiment.

20. The computer program product according to claim 14, wherein program instructions to confirm the candidate is committed to the accepted job offer is selected from a group consisting of program instructions to contact the candidate, program instructions to confirm all of a plurality of questions of from the candidate are answered, and program instructions to offer an enhanced job offer to the candidate.
